(19) United States
(12) Patent Application Publication
(10) Pub. No.: US 2026/0093759 A1
(43) Pub. Date: Apr. 2, 2026

(54) INFORMATION SEARCH METHOD, ELECTRONIC DEVICE, AND STORAGE MEDIUM

(71) Applicant: Lenovo (Beijing) Limited, Beijing (CN)

(72) Inventors: Xuejin WANG, Beijing (CN); Mingping ZHANG, Beijing (CN); Hainan CAI, Beijing (CN)

(21) Appl. No.: 19/340,865

(22) Filed: Sep. 26, 2025

(30) Foreign Application Priority Data
Sep. 30, 2024 (CN) 202411391722.4

(51) Int. Cl. G06F 16/953

(52) U.S. Cl. CPC G06F 16/953

(57) ABSTRACT

An information search method includes in response to a first operation, displaying a search box and controlling an input cursor to be located within the search box; in response to the first operation, responding in real time to each input character in the search box with a first search engine, searching for first target objects that match first target characters in the search box, where the first target characters are all characters in the search box when responding to the input character; updating the first target objects displayed in real time; and in response to a second operation, searching with a second search engine for second target objects that match second target characters in the search box, where the second target characters are all characters in the search box; displaying the second target objects, and a second target object is not a character-type object.

### CROSS-REFERENCE TO RELATED APPLICATION

This application claims priority to Chinese Patent Application No. 202411391722.4, filed on Sep. 30, 2024, the content of which is incorporated herein by reference in its entirety.

### TECHNICAL FIELD

The application relates to the field of information processing technology, in particular to an information search method, an information search device, and an electronic device.

### BACKGROUND

Users often need to use electronic devices to search for objects such as documents, applications, or images.

To ensure the accuracy of information searches, currently, electronic devices detect a user's search command and use the characters entered in the search box as search keywords to search for objects. However, it takes a certain amount of time for the user to complete the search keyword input and for the electronic device to search for objects based on the search keywords, resulting in a long time before the user can see the search results. Therefore, how to reduce the time users spend waiting for object search results while ensuring search accuracy, so that users can view the searched objects in a timely manner, is a technical problem that needs to be solved by those skilled in the art.

### SUMMARY

In one aspect, the present disclosure provides an information search method, and the method includes in response to a first operation, displaying a search box and controlling an input cursor to be located within the search box; in response to the first operation, responding in real time to each input character in the search box with a first search engine, searching for first target objects that match first target characters in the search box, where the first target characters are all characters in the search box when responding to the input character; updating the first target objects displayed in real time; in response to a second operation, searching with a second search engine for second target objects that match second target characters in the search box, where the second target characters are all characters in the search box; and displaying the second target objects, where the second search engine includes a first target model, the first target model is configured to at least understand semantics of the second target characters, and a second target object is not a character-type object.

In another aspect, the present disclosure provides electronic device. The electronic device includes one or more processors and a memory containing a computer program that, when being executable, causes the one or more processors to perform: in response to a first operation, displaying a search box and controlling an input cursor to be located within the search box; in response to the first operation, responding in real time to each input character in the search box with a first search engine, searching for first target objects that match first target characters in the search box, where the first target characters are all characters in the search box when responding to the input character; updating the first target objects displayed in real time; in response to a second operation, searching with a second search engine for second target objects that match second target characters in the search box, where the second target characters are all characters in the search box; and displaying the second target objects, where the second search engine includes a first target model, the first target model is configured to at least understand semantics of the second target characters, and a second target object is not a character-type object.

In another aspect, the present disclosure provides an electronic device. The electronic device includes an input device, one or more processors, and a display screen. The electronic device further includes: a search box display module running on a corresponding processor of the one or more processors and configured to, in response to a first operation received via an input device, cause the corresponding processor to present a search box in the display screen and cause the corresponding processor to control an input cursor to be located within the search box; a first search module running on a corresponding processor of the one or more processors and configured to, in response to the first operation, cause on the a corresponding processor o respond in real time to each input character entered through the input device into the search box by implementing a first search engine to search for first target objects matching first target characters located in the search box, the first target characters being all characters within the search box when the corresponding processor responds to the input character; a first display module running on a corresponding processor of the one or more processors and configured to cause the corresponding processor to update in real time the first target objects displayed on the display screen; a second search module running on a corresponding processor of the one or more processors and configured to, in response to a second operation received via the input device, cause the corresponding processor to implement a second search engine to search for second target objects matching second target characters located in the search box, the second target characters being all characters within the search box; and a second display module running on a corresponding processor of the one or more processors and configured to cause the corresponding processor to present the second target objects on the display screen. The second search engine includes a first target model configured to at least understand a semantics of the second target characters, and a second target object is not a character-type object.

In another aspect, the present disclosure provides an electronic device,
including a processor and a display screen, and the electronic device further including: a search box display module running the processor and configured to, in response to a first operation received via an input device, cause the processor to present a search box in the display screen and cause the processor to control an input cursor to be located within the search box; a first search module running the processor and configured to, in response to the first operation, cause the processor to respond in real time to each input character entered through the input device into the search box by implementing a first search engine to search for first target objects matching first target characters located in the search box, the first target characters being all characters within the search box when the processor responds to the input character; a first display module running on the processor and configured to cause the processor to update in real time the first target objects displayed on the display screen; a second search module running on the processor and configured to, in response to a second operation received via the input device, cause the processor to implement a second search engine to search for second target objects matching second target characters located in the search box, the second target characters being all characters within the search box; and a second display module running on the processor and configured to cause the processor to present the second target objects on the display screen, where the second search engine includes a first target model configured to at least understand a semantics of the second target characters, and a second target object is not a character-type object.

It should be understood that the content described in this section is not intended to identify the key or important features of the embodiments of the present disclosure, nor is it intended to limit the scope of the present disclosure. Other features of the present disclosure will become easily understood through the following brief description of the drawings and the detailed description.

### BRIEF DESCRIPTION OF THE DRAWINGS

In order to more clearly illustrate the technical solutions in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a flowchart of an information search method, according to an embodiment of the disclosure;

FIG. 2 is a flowchart of another information search method, according to an embodiment of the disclosure;

FIG. 3 is a flowchart of another information search method, according to an embodiment of the disclosure;

FIG. 4 is a diagram showing an example application of the disclosed solution, according to an embodiment of the disclosure;

FIG. 5 is a schematic diagram of structural components of an information search device, according to an embodiment of the disclosure;

FIG. 6 is a schematic diagram of structural components of another information search device, according to an embodiment of the disclosure; and

FIG. 7 is a schematic diagram of structural components of an electronic device, according to an embodiment of the disclosure.

### DETAILED DESCRIPTION

The embodiments of the present disclosure are described hereinafter in conjunction with the drawings in the embodiments of the present disclosure. The terms used in the embodiments of the present disclosure are merely used to explain the specific embodiments of the present disclosure and are not intended to limit the present disclosure. It is known to those skilled in the art that with the development of technology and the emergence of new scenarios, the technical solutions provided in the embodiments of the present disclosure are also applicable to similar technical problems.

The terms “first”, “second”, etc., in the specification and claims of the present disclosure and the accompanying drawings are used to distinguish similar objects, and are not necessarily used to describe a specific order or sequential order. It should be understood that the terms used in this way may be interchangeable under appropriate circumstances, and this is merely a way of distinguishing the objects of the same attributes when describing them in the embodiments of the present disclosure. In addition, the terms “including” and “comprising” and any of their variations are intended to cover non-exclusive inclusions, so that the process, method, system, product or equipment comprising a series of modules need not be limited to those modules, but may include other modules that are not clearly listed or inherent to these processes, methods, products or equipment.

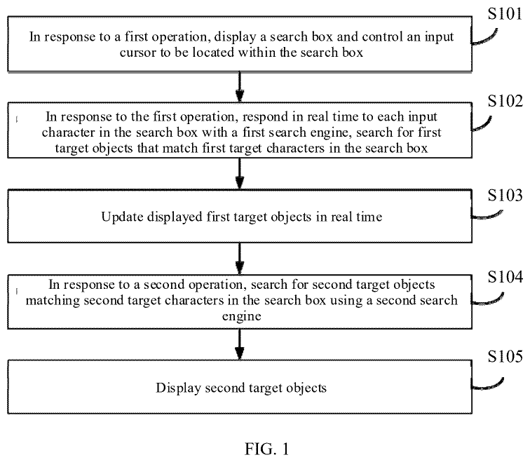

FIG. 1 is a flowchart of an information search method provided in an embodiment of the present disclosure. The method of the disclosed embodiment may be applied to electronic devices, which may be user devices such as mobile phones, laptops, or tablet computers, or devices such as servers, without limitation.

The method of the disclosed embodiment may include the following.
S101: In response to a first operation, display a search box and control an input cursor to be located in the search box.

Here, the first operation is an operation for inputting to-be-searched characters. Since the premise of inputting to-be-searched characters is that there is a search box and the input cursor is located in the search box, therefore, in response to the first operation, the application needs to control the input cursor to be located in the displayed search box so that a user can input the to-be-searched characters into the search box.

It is to be noted that if the search box is not displayed before the first operation is detected, the search box needs to be displayed and the input cursor needs to be controlled to be located within the search box. For example, the first operation includes: clicking an icon for triggering the search mode, and in response to the click operation, the search box is displayed and the input cursor is to be controlled to be located within the search box.

If a search box is already displayed before the first operation is detected, the search box may be maintained without displaying it again, and the input cursor may be controlled to be located within the search box. For example, if the first operation includes an operation for moving the input cursor to the search box and positioning it, the input cursor may be controlled to be located within the search box.
S102: In response to the first operation, respond in real time to each input character in the search box with a first search engine, and search for first target objects that match first target characters in the search box.

It is noted that inputting to-be-searched characters involves positioning the input cursor in the search box and inputting characters once or multiple times in the search box. Therefore, the first operation may include a continuous input operation lasting a certain period of time, or multiple continuous input actions. Based on this, when the input cursor is located in the search box, the present disclosure will also respond to the first operation by responding in real time to each input character entered into the search box through the first search engine to perform a search operation.

The first target characters are all the characters in the search box when responding to the input characters.

Based on this, each time the first search engine performs a search operation, the first search engine uses all characters currently entered in the search box as the first target characters and searches for matching objects based on the first target characters. In other words, each time the user enters a character in the search box through the first operation (including entering a new character or modifying the existing characters), the first search engine responds to the currently entered characters and searches for objects that match all characters currently entered in the search box.

In the present disclosure, for the sake of distinction, an object searched by the first search engine is referred to as a first target object.

In the present disclosure, the first target object is not a character, but an entity object other than a character-type object. For example, the first target object may be a document, an image, a webpage, an application, etc. Based on this, the process of the first search engine searching for the first target objects that match the first target characters is different from searching for a character string that the user may enter based on the first target characters.
S103: Update the displayed first target objects in real time.

In the present disclosure, the first search engine may respond to each character entered in the search box in real time. Whenever a character is entered in the search box, the first search engine will be triggered to search for the first target objects, and the first target objects searched each time may be different. Therefore, in order to enable a user to intuitively see the objects that currently match all the characters entered in the search box, each time the first search engine responds to the input character to search for the first target objects, it is necessary to display the currently searched first target objects to achieve real-time updating of the displayed first target objects.

For example, if a user wants to search for objects that match “white color of cat,” after the user enters “white” in the search box, the first search engine will search for and display first target objects that match “white.” If the user continues to enter “color” in the search box, and “white” is already entered in the search box, the first search engine will search for and display first target objects that match “white color.” Similarly, if the user continues to enter “of,” the first search engine will search for and display first target objects that match “white color of.” Finally, when the user enters “white color of cat” in the search box, the first search engine will search for and display first target objects that match “white color of cat.”

It is to be noted that the first search engine may search for one or more first target objects each time. After each search, if the first search engine finds multiple first target objects, the first target objects with the highest matching degrees may be displayed in descending order of matching degree between the first target objects and the first target characters. For example, a set number (e.g., 10 or 20, which may be set as needed) of the first target objects with the highest matching degrees may be displayed each time.

It is to be noted that, while a user is entering characters into the search box, the first target objects that match all the characters entered into the search box are searched for in real time and continuously updated, allowing the user to promptly see the search results that match the currently entered characters. On this basis, while a user is entering characters into the search box, if the user sees that an object the user is looking for is among the displayed first target objects, the user may directly click on the corresponding object to view it without having to continue entering characters, thus improving the efficiency of the user's object search.
S104: In response to a second operation, search for second target objects matching second target characters in the search box by using a second search engine.

The second operation is different from the first operation.

For example, the second operation is an operation for indicating the end of inputting the search string, that is, an operation for indicating the end of the first operation. For example, the second operation may be an operation of inputting Enter, or an operation of clicking a search icon associated with the search box.

The second target characters are all the characters in the search box, that is, all the characters in the search box when responding to the second operation.

The second search engine is different from the first search engine. In the present disclosure, the second search engine includes a first target model, which is used to at least understand the semantics of the second target characters. For example, the first target model may be any artificial intelligence model with a semantic understanding capability. For example, the first target model may be a neural network model or a large language model, etc., without limitation.

For example, large language model (LLM) may be a machine learning model, based on deep neural network architectures such as the Transformer, that has been trained on large-scale corpora of natural language data. An LLM contains a very high number of parameters, e.g., in the order of billions or more, which enables LLM to capture statistical patterns, semantic relationships, and/or contextual dependencies in human language. The LLM can perform tasks including, but not limited to: natural language understanding (e.g., intent recognition, information extraction), natural language generation (e.g., text completion, summarization, dialogue response), reasoning and decision support, code generation, and multi-modal integration (in some cases). LLMs may operate by processing input sequences of tokens (text units) and predicting subsequent tokens in context, which allows them to generate coherent, contextually appropriate text. The large parameter size and training data scale distinguish LLMs from conventional language models, providing broader generalization and adaptability across domains without task-specific training.

In one embodiment, LLM can be applied in multimodal retrieval tasks and may include, a text-to-image retrieval model, an image-to-image retrieval model, or any suitable model. The text-to-image retrieval model may be configured to retrieve/output, from an image database, a target image relevant, to an input text. The LLM may be configured to understand the semantics of the text, generating retrieval instructions, or aligning the query into a multimodal embedding space to find the corresponding image. The image-to-image retrieval model may be configured to retrieve, from an image database, a target image having features similar to those of an input image. The LLM may be configured to extract semantic descriptions of the reference image or assist in cross-modal alignment for retrieval. Accordingly, the second search engine may search for objects that match the semantics of the second target characters based at least on the semantics of the second target characters.

For the sake of distinction, an object searched by the second search engine is referred to as a second target object.

In the present disclosure, the second target object is not of character type, that is, the second target object may be an entity object other than a character-type object. For example, the second target object may be a document, file, image, web page or application.
S105: Display the second target objects.

It is to be noted that the second target objects found by the second search engine may be one or more objects. In the case of multiple second target objects found, all of them may be displayed. If the object display area is relatively limited, a predetermined number of second target objects with the highest matching degrees may be displayed based on the matching degrees with the second target characters.

From the above descriptions, it can be seen that in response to the first operation, the present disclosure may respond to each input character in the search box in real time with the first search engine, search for the first target objects that match all the characters currently in the search box, and update the displayed first target objects in real time. Therefore, in the process of the user inputting characters into the search box, as the input characters in the search box change, the target objects that match the characters entered by the user are displayed in real time, so that the user may view the target objects that match the currently entered characters in a timely manner. Moreover, in response to the second operation, the present disclosure will also search for the second target objects that match all the characters in the search box with the second search engine. Since the second search engine includes a first target model for understanding the semantics of characters, the second search engine may more accurately search for objects that match all the characters in the search box, thereby making up for the situation where the first search engine cannot accurately search for the objects required by the user in real time, thereby achieving the purpose of taking into account both search timeliness and search accuracy, and naturally improving the user's search experience.

It is to be noted that, in the present disclosure, after the second target objects are searched, only the second target objects may be displayed. In order to improve the comprehensiveness of the search results, the present disclosure may also display the first target objects that were most recently searched while displaying the second target objects.

Furthermore, in order to enable users to intuitively understand the search sources of different target objects, when displaying the second target objects and the first target objects searched most recently, the present disclosure may also respectively mark the first source information corresponding to the first target objects and the second source information corresponding to the second target objects. The first source information is used to indicate that the first target objects are obtained by searching using the first search engine, and the second source information is used to indicate that the second target objects are obtained by searching using the second search engine.

The first source information may be an icon or character representing the first search engine, and the second source information may be an icon or character representing the second search engine, which is not limited in the present disclosure.

It is to be noted that when displaying the first target objects and the second target objects simultaneously, the first target objects may be displayed in the first display region of the search results display area, and the second target objects may be displayed in the second display region of the search results display area. Based on this, the first source information may be marked in the first display region, and the second source information may be marked in the second display region.

If the electronic device is a user device such as a mobile phone, the search results display area may belong to at least a portion of the display module of the electronic device. If the electronic device is a server, the search results display area may belong to at least a portion of the display module of the client terminal corresponding to the server.

In the present disclosure, there are many possible ways to implement the second search engine searching for the second target objects.

In one embodiment, the second search engine is used to search the electronic device for second target objects that match the second target characters. In this case, because the first search engine and the second search engine use different search methods, the second target objects found by the second search engine are different from the first target objects. That is, the second target objects found by the second search engine may be partially or completely different from the first target objects found by the first search engine. For example, the second target objects found by the second search engine may include objects that do not belong to the first target objects.

In one embodiment, in order to improve search efficiency, searching for the second target objects using the second search engine may be as follows: processing the second target characters and the first target objects based on the first target model, and determining, from the first target objects, a first target object that meets the semantics of the second target characters as a second target object.

The first target model processes the second target characters and the second target objects by determining the semantics of the second target characters and matching the semantics of a second target object with the semantics of the second target characters. The semantics of a second target object may be predetermined or recognized in real time by the first target model, without limitation.

Here, the second search engine determines the second target objects from the first target objects, which may reduce the object search volume and may also determine the second target objects that better match the characters entered in the search box from the searched first target objects, thereby improving the accuracy of the object search.

In the present disclosure, there are many possibilities for the first search engine and the second search engine.

In one embodiment, the first search engine may search for the first target objects by matching the first target characters with the names corresponding to the objects, i.e., searching for the first target objects whose corresponding characters match the first target characters. Here, the characters corresponding to the objects may be the name or identity characters of the objects. For example, the first search engine may match the first target characters with the names of various objects in an electronic device to search for the first target objects whose names match the first target characters.

The second search engine may match the vector features of the second target characters with the vector features corresponding to the objects, thereby searching for the second target objects whose corresponding vector features match the vector features corresponding to the second target characters.

For example, based on the first target model in the second search engine, vector features corresponding to the second target characters may be determined, and second target objects whose vector features match the vector features of the second target characters may be determined. The vector features of the second target characters may also be called a feature vector, which may represent the semantics of second target characters.

The vector features of an object may represent its attributes, such as its content, function, and origin. For example, if an object is an application, its vector features may be determined based on its attributes, such as its application type, name, and developer. If an object is an image, the image may be encoded to obtain vector features reflecting its content. If an object is a document, its vector features may be determined based on its content and name. These vector features may then reflect the document's semantic information.

The vector features of objects in the electronic device may also be determined in real time by the first target model. To improve search efficiency, the vector features of objects in the electronic device may be predetermined. For example, an object vector library may be maintained in the electronic device, which includes the vector features of each object in the electronic device. Furthermore, each time an object is added to the electronic device, the vector features of the object are determined and added to the object vector library.

Here, the second target objects matched by the vector features and the vector features corresponding to the second target characters may be a set of objects with the highest matching degrees between the vector features of these objects and the vector features corresponding to the second target characters, or the objects whose matching degrees exceed a set threshold. Apparently, there may be other possibilities, which are not limited to this.

It is to be noted that the objects local to the electronic device are limited. Therefore, it is very likely that the second search engine will not be able to search for any second target object. Based on this, in the present disclosure, in addition to being able to search for objects based on a second target model, the second search engine may also support object generation. On this basis, the first target model may include a first generative model.

Accordingly, in response to the second operation, the electronic device may first use the second search engine to search for second target objects that match the second target characters. If the second search engine does not find any second target object, the electronic device may use the first generative model in the second search engine to generate a second target object that matches the second target characters.

For example, the first target model includes a first intelligent model and a first generative model. On this basis, in response to the second operation, the electronic device will first search for second target objects that match the second target characters based on the first intelligent model in the second search engine. For example, the vector features of the second target characters are determined based on the first intelligent model in the second search engine, and the second target objects are determined based on the vector features of the second target characters and the vector features of the objects in the electronic device. If no second target object is found based on the first intelligent model, a second target object that matches the second target characters is generated based on the first generative model. For example, an image or text that matches the second target characters is generated.

In order to use the first intelligent model of the first target model to search for the second target objects that match the second target characters, the electronic device may generate a first prompt statement in response to the second operation. The first prompt statement may include the second target characters, and the first prompt statement is used to prompt the first target model to search for an object based on the second target characters. Accordingly, based on the search prompt statement, the first intelligent model in the first target model is configured to search for the second target objects that match the second target characters. For example, when the first target model is called, the search prompt statement is input so that the first target model searches for the second target objects through the first intelligent model.

Similarly, if no second target object is found based on the first target model, the electronic device may generate a second prompt statement, which may include the second target characters, and the second prompt statement is configured to prompt the generation of an object based on the second target characters.

It should be noted that the first intelligent model and the first generative model may be two independent models. In actual applications, the first intelligent model and the first generative model may also be the same model. In this case, the first intelligent model and the first generative model may both be parts of the first target model, and the first target model not only has semantic recognition capabilities, but also has object generation capabilities.

In the above embodiments of the present disclosure, the target objects searched by the first search engine and the second search engine may be objects stored or installed locally on the electronic device, such as applications installed on the electronic device, documents, web pages, or images stored on the electronic device or in a database maintained by the electronic device.

In actual applications, considering that the range of objects that may be searched by an electronic device is relatively limited, or that the user wants to view objects on other devices, there is also a need to use other terminal devices to synchronously search for objects that match the second target characters. Based on this, in the present disclosure, in response to the second operation, if there is at least one terminal device in an active state, the second target characters and a calling request for calling a second target model on a terminal device are sent to the at least one terminal device through the communication channel between the at least one terminal device and the electronic device, so that each terminal device may process the second target characters based on the second target model.

Here, a terminal device in an active state is a terminal device that has established a communication channel with the electronic device, and the communication channel is in an available state, so that data may be transmitted between the electronic device and the terminal device.

For example, an electronic device may maintain terminal devices that establish communication channels with the electronic device and the current connection status of the communication channels between each terminal device and the electronic device, and determine, from the terminal devices that establish communication channels with the electronic device, at least one terminal device in which the communication channel is in a connected state.

Here, the second target model on a terminal device in an active state may be any artificial intelligence model. The second target model may be a model of the same type as the first target model, or a model of a different type, which is not limited in the present disclosure.

The process of the second target model processing the second target characters is similar to the process of the first target model processing the first target characters, which will not be repeated here.

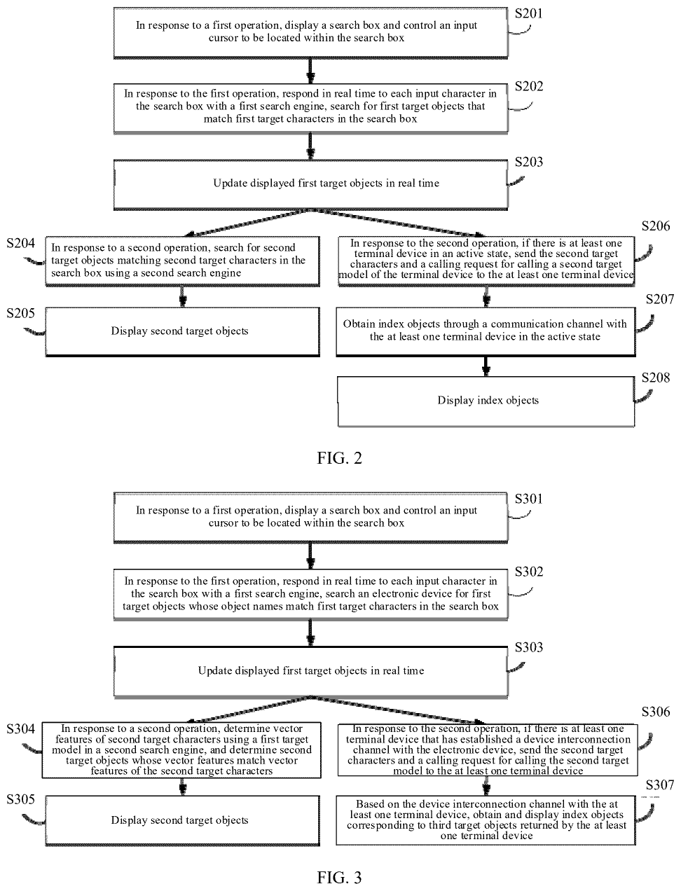

Furthermore, the electronic device may also obtain the processing result of the second target characters returned by the at least one smart terminal through a communication channel with the at least one smart terminal in an active state. For ease of understanding, the following description is provided in conjunction with a possible implementation method. FIG. 2 is a flowchart of an information search method provided in an embodiment of the present disclosure. The method of the disclosed embodiment is applied to an electronic device and may include the following.
S201: In response to a first operation, display a search box and control an input cursor to be located within the search box.
S202: In response to the first operation, respond in real time to each input character in the search box with a first search engine, and search for first target objects that match first target characters in the search box.

The first target characters are all characters in the search box when responding to the input character.
S203: Update the displayed first target objects in real time.

For the above steps S201 to S203, reference may be made to the relevant descriptions of the previous embodiments and will not be repeated here.
S204: In response to a second operation, search for second target objects matching second target characters in the search box using a second search engine.

The second target characters are all the characters in the search box.

The second search engine includes a first target model, where the first target model is at least used to understand the semantics of the second target characters, and a second target object is not a character-type object.

In one embodiment, the first target model includes a first intelligent model and a first generative model, and the first intelligent model is used in the second search engine to search for second target objects that match the second target characters, such as determining a second target object that semantically matches the second target characters from the first target objects based on the first intelligent model, or matching a second target object, in the electronic device, whose vector features match the vector features of the second target characters based on the first intelligent model.

Further, if no second target object is found based on the first intelligent model, a second target object matching the second target characters is generated based on the first generative model, and step S205 is executed.

The specific implementation of step S204 may be found in the related descriptions of the previous embodiments and will not be repeated here.
S205: Display the second target objects.
S206: In response to the second operation, if there is at least one terminal device in an active state, the second target characters and a calling request for calling the second target model on the terminal device are sent to the at least one terminal device through a communication channel between the at least one terminal device and electronic device, so that each terminal device may process the second target characters based on the second target model.

A terminal device may be a device of the same type as the electronic device, or may be a device of a different type from the electronic device, which is not limited in the present disclosure.

Here, a terminal device in the active state establishes a communication channel with the electronic device, and the communication channel is in an available state capable of transmitting data.

In one embodiment, the electronic device may also be a user terminal such as a mobile phone or a laptop computer, and a terminal device in an active state may be a terminal device that has established an interconnection channel with the electronic device.

The interconnection channel is a communication channel established based on the pairing information between the electronic device and the terminal device. The interconnection channel may also be called a device interconnection channel or a device direct connection channel. On the premise that an interconnection channel is established between the electronic device and the terminal device, data may be directly transmitted between the electronic device and the terminal device without the help of a third-party device for data forwarding. Through the interconnection channel between the electronic device and the terminal device, file transfer, screen projection, and mutual control may be achieved.

For example, the interconnection channel may be a direct connection channel established between the electronic device and the terminal device based on Wi-Fi direct connection; may be a peer-to-peer (P2P) direct connection channel established based on the P2P technology; or may be a direct connection channel established with the help of a wireless network or the same local area network, etc. The interconnection channel may be also a direct connection established based on a USB connection between the electronic device and the terminal device using pairing information between the electronic device and the terminal device, which is not limited in the disclosure.

In the case where an interconnection channel is established between the electronic device and at least one terminal device, in response to the second operation, the electronic device sends the second target characters and a calling request to each terminal device through the interconnection channel established with each terminal device.

It should be noted that, in actual applications, step S205 may be executed simultaneously with step S204; step S204 may be executed first, and then step S205; or step S205 may be executed first, and then step S204.
S207: Obtain index objects through a communication channel with at least one terminal device in an active state.

An index object is used to obtain a third target object, which is a target object determined by the second target model on the terminal device and matches the second target characters.

For example, the index object may be an object address or link for locating a third target object, or may be an identity such as the name or thumbnail of the third target object, which is not limited here.

It is to be noted that the process of processing the second target characters and determining a third target object on the terminal device may be similar to the process of processing the second target characters and determining a second target object by the electronic device.

For example, the terminal device may search for third target objects that match the second target characters based on the second target model. For example, the terminal device searches for third target objects that semantically match the second target characters. In one example scenario, the second target model includes a second intelligent model, and the terminal device may search for third target objects that match the second target characters based on the second intelligent model.

For another example, the second target model in the terminal device includes a second generative model. In this case, a third target object may be an object generated by the terminal device based on the second generative model.

In particular, when no third target object is found based on the second intelligent model, the terminal device may generate a third target object that matches the second target characters based on the second generative model.

It is to be noted that the model type of the second target model on different terminal devices may be different. For example, the second target model on some terminal devices is a generative model, the second target model on some terminal devices is an intelligent model that only understands character semantics, and the second target model on some smart terminals may include a generative model and an intelligent model for understanding character semantics.

Based on this, in one embodiment, in order to enable a terminal device in an active state to reasonably process the second target characters and reduce the risk of the terminal device being unable to process the second target characters, the electronic device may also send the second target characters and a calling request for calling the second target model on the terminal device to the at least one terminal device based on an intelligent model capability of the at least one terminal device.

Here, the intelligent model capability possessed by a terminal device is used to indicate the model type of the second target model in the terminal device, that is, to indicate the character processing mode that the second target model in the terminal device may support. The character processing mode may include: at least one of the ability to understand character semantics and the ability to generate objects.

For example, if the second target model in a terminal device includes a second intelligent model, and the intelligent model capability of the terminal device includes the ability to understand the semantics of characters, in this case, the electronic device may send the second target characters to the terminal device and send a calling request to the terminal device for calling the second target model to recognize the semantics of the second target characters, so that the terminal device matches third target objects based on the semantics of the second target characters.

If the second target model in the terminal device includes a second generative model, and the intelligent model capability of the terminal device includes the capability to generate objects, the electronic device may send the second target characters and a calling request to call the second target model to generate an object matching the second target characters to the terminal device.

The intelligent model capability of the terminal device may be notified to the electronic device by the terminal device after a communication channel is established between the terminal device and the electronic device. For example, the terminal device sends a capability notification to the electronic device, where the capability notification indicates the intelligent model capability of the terminal device.

Apparently, if the second target model in the terminal device includes a second intelligent model and a second generative model, the electronic device may send second target characters and a calling request to call the second target model to the terminal device. The calling request is used to instruct the terminal device to search for third target objects that match the second target characters based on the second intelligent model, and if the third target object cannot be matched based on the second intelligent model, a third target object that matches the second target characters is generated based on the second generative model.
S208: Display index objects.

Step S208 is an optional step, and its purpose is to enable the user to realize, based on the displayed index objects, that there are third target objects matching the second target characters on the terminal device.

It is to be noted that since the electronic device is triggered to process the second target characters while matching the second target objects, the electronic device may not only match the second target objects but also obtain the index objects corresponding to the third target object. Based on this, the electronic device may display the second target objects at the same time as displaying the index objects.

Furthermore, to enable the user to intuitively distinguish the sources of the index objects and the second target objects, the electronic device may also indicate the second source information of the second target objects and the third source information of the index objects. The second source information may be found in the previous description. The third source information indicates that a third target object corresponding to an index object is an object obtained based on the second target model by a terminal device in an active state.

In actual applications, while displaying the second target objects and the index objects, the first target objects obtained by the most recent search may also be displayed synchronously. Apparently, the source information corresponding to each object may also be marked separately.

To facilitate understanding of the solutions of the disclosure and their benefits, an application scenario is introduced below.

When users use electronic devices, they often need to search for objects such as documents, images, or applications on the electronic devices. However, the current search method is based on matching the search keywords entered by the user with the names of the objects on the electronic devices, which makes the object search neither timely nor accurate. Moreover, if a user has multiple electronic devices, if the user needs to check whether certain objects are available on each electronic device separately, the user needs to search for the objects on multiple electronic devices separately, which inevitably leads to a high complexity in the search object.

Based on this, the present disclosure may achieve a more comprehensive, efficient and accurate search for objects on multiple electronic devices by leveraging the premise that electronic devices may achieve direct communication based on device interconnection.

FIG. 3 is a flowchart of an information search method of the present disclosure in an application scenario. The method of the disclosed embodiment may be applied to an electronic device, which may be a mobile phone, a laptop computer or another different terminal device.

The method of the disclosed embodiment may include the following.
S301: In response to a first operation, display a search box and control an input cursor to be located within the search box.
S302: In response to the first operation, respond in real time to each input character in the search box with a first search engine, search an electronic device for first target objects whose object names match the first target characters in the search box.

The first target characters are all the characters in the search box when responding to the input character.

For example, a device interconnection application for establishing device interconnection may be deployed in the electronic device. Taking the implementation of the disclosed embodiment based on the device interconnection application as an example, the following is explained.

The first operation may be a series of operations in which the user moves the cursor to the search box of the device interconnection application and performs character input, or a series of operations in which the user clicks the search icon and enters the to-be-searched characters. Based on this, in response to the cursor moving to the search box or clicking the search icon, the device interconnection application may display the search box (or maintain the search box display) and control the input cursor to be positioned within the search box. Based on this, each time the user performs a character input operation, the first operation is confirmed, and in response to the user's character input, the first search engine is called to search the electronic device for each first target object whose object name matches the characters entered in the search box.

The first search engine does not utilize an artificial intelligence model and does not involve a semantic search for the first target character. Instead, the first search engine simply matches the first target characters with the object names of various objects present in the electronic device (such as installed or stored) to determine at least one first target object.

From the above, it can be seen that the first target object is not an object generated or predicted by the first search engine, but an object that the electronic device actually has.
S303: Update displayed first target objects in real time.

For example, at least one first target object currently searched is displayed in real time in the application interface of the device interconnection application of the electronic device, so that the first target objects presented in the application interface of the device interconnection application may be continuously updated while the user inputs characters into the search box.

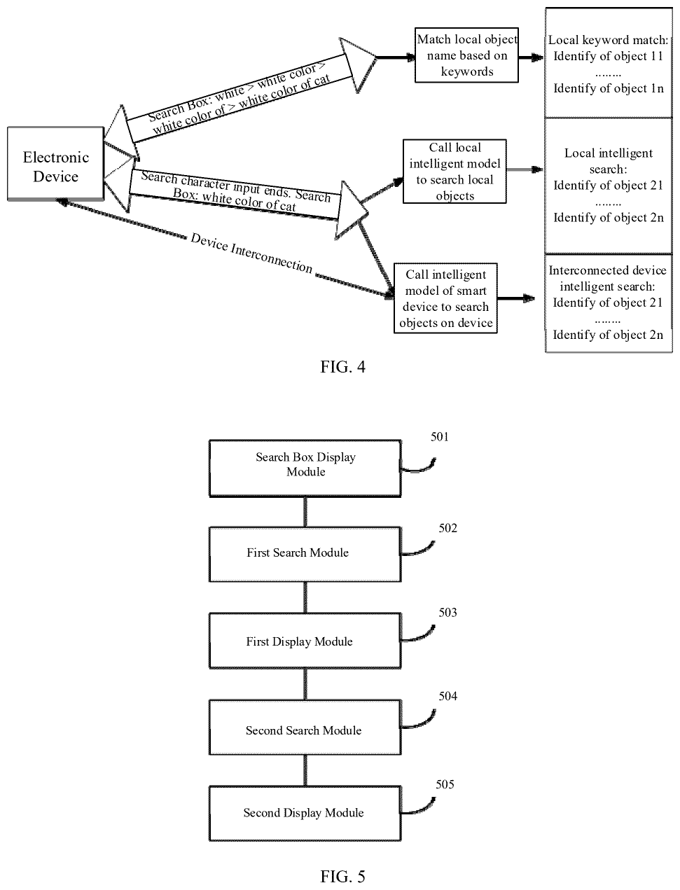

Referring to FIG. 4, in the illustrated embodiment, as a user enters “white color of cat” in the search box, each time the user enters a character, the first search engine is called to perform keyword matching. The first search engine then matches the names of objects in the electronic device with the characters currently in the search box and displays the target objects. Therefore, as the user enters “white color of cat,” each time the user enters a character, the objects in the object display area corresponding to the local keyword search in the device interconnection application interface shown in FIG. 4 will change, displaying objects that match the user's current search terms in real time.
S304: In response to a second operation, determine vector features of second target characters in the search box using a first target model in a second search engine, and determine second target objects in the electronic device whose vector features match vector features of the second target characters.

The second target characters are all characters in the search box in response to the second operation. The vector features of the second target characters may represent the semantics of the second target characters.

In one embodiment, the electronic device may pre-construct the vector features of each object in the electronic device. For example, taking a device interconnection application deployed on an electronic device as an example, when the device interconnection application detects the presence of a new object (the latest installed or stored object) in the electronic device, the device interconnection application may call the first target model to generate the vector features of the new object and store it in the object vector library. On this basis, in response to the second operation, after the device interconnection application calls the first target model to determine the vector features of the second target characters, the first target model may determine the second target objects whose vector features match the vector features of the second target characters based on the vector features of each object in the object vector library.

A second target object is an object installed or stored in the electronic device, rather than a character-type object.
S305: Display the second target objects.
S306: In response to the second operation, if there is currently at least one terminal device that has established a device interconnection channel with the electronic device, send the second target characters and a calling request for calling the second target model on the terminal device to the at least one terminal device, so that the at least one terminal device searches for third target objects that semantically match the second target characters from the terminal device based on the second target model.
S307: Based on the device interconnection channel with the at least one terminal device, obtain and display index objects corresponding to the third target objects returned by the at least one terminal device.

An index object is used to obtain a third target object. For example, the index object is at least one of a storage address, an installation location, and an object name of the third target object.

To briefly illustrate the example of FIG. 4, the second operation may be clicking the search icon associated with the search box. For example, when an electronic device completes a local and connected device object search through a device interconnection application, after the user enters “white color of cat” into the search box, the user has completed the full search keyword input. Based on this, the user may click the search icon associated with the search box. Once the device interconnection application detects the user clicking the search icon, the device may call the first target model to identify the vector features of “white color of cat” and match the vector features of each object in the object vector library. It then determines second target objects on the electronic device that semantically match “white color of cat” and displays them in the local smart search display area of the device interconnection application's application interface.

At the same time, in response to the user clicking the search icon, the electronic device, through the interconnected device application, will also send the characters “white color of cat” and a request, to call the intelligent model on a terminal device, to the terminal device with which the electronic device has established a device interconnection. In response to the request, the terminal device will call the intelligent model to identify third target objects that semantically match “white color of cat” and return the index objects corresponding to the third target objects to the electronic device. The electronic device will display the index objects in the interconnected device's intelligent search display region in the application interface of the device interconnection application.

Based on this, after the user completes inputting “white color of cat” and clicks the search icon, the electronic device will eventually display the objects searched locally based on the keywords, the objects searched locally based on the local intelligent model, and the index objects for the objects searched through the intelligent model through a terminal device that has established device interconnection with the electronic device.

Corresponding to the information search methods of the present disclosure, the present disclosure also provides an information search device.

FIG. 5 shows a schematic structural diagram of an information search device according to an embodiment of the disclosure. The device of the disclosed embodiment may include the following.

A search box display module 501 is configured to display a search box and control an input cursor to be located within the search box in response to a first operation.

A first search module 502 is configured to respond to the first operation by using a first search engine to respond in real time to each input character in the search box, search for first target objects that match first target characters in the search box, where the first target characters are all characters in the search box when responding to the input character.

A first display module 503 is configured to update displayed first target objects in real time.

A second search module 504 is configured to search for second target objects matching second target characters in the search box using a second search engine in response to a second operation, where the second target characters are all characters in the search box.

A second display module 505 is configured to display the second target objects, where the second search engine includes a first target model, the first target model is at least configured to understand the semantics of the second target characters, and a second target object is not a character-type object.

In one embodiment, the second search module is specifically configured to process the second target characters and the first target objects based on the first target model, and determine, from the first target objects, a first target object that meets the semantics of the second target characters as a second target object.

In another embodiment, the first search module, when searching for the first target objects that match the first target characters in the search box, is specifically configured to search for the first target objects whose corresponding characters match the first target characters.

When searching for a second target object that matches the second target characters in the search box using a second search engine, the second search module is specifically configured to search for second target objects whose corresponding vector features match the vector features corresponding to the second target characters in the search box using the second search engine.

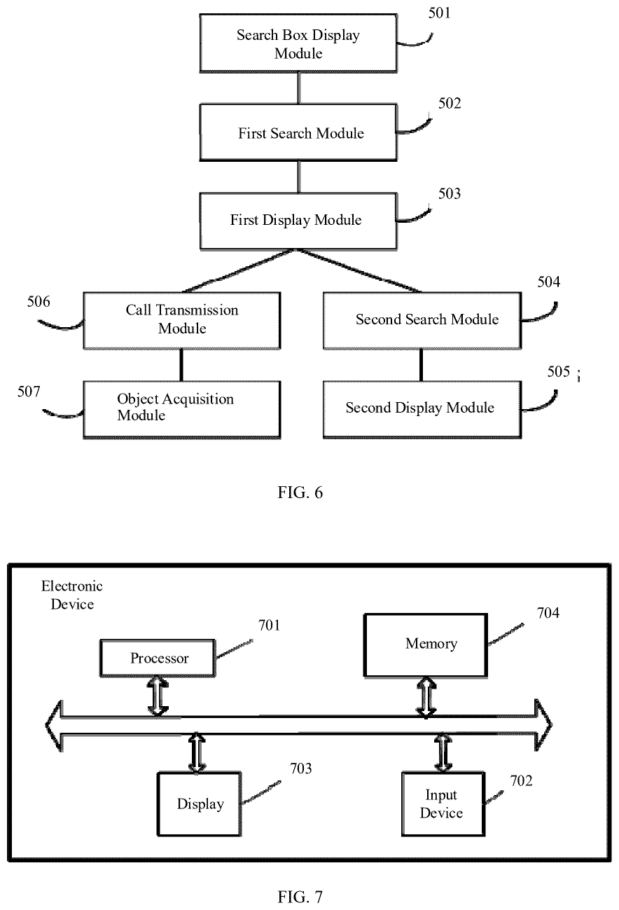

In one embodiment, the information search device of the present disclosure may be as shown in FIG. 6, which shows another schematic diagram of the structural components of the information search device.

In addition to the search box display module 501, the first search module 502, the first display module 503, the second search module 504 and the second display module 505, FIG. 6 also includes the following.

A call transmission module 506 is configured to respond to the second operation and, if there is at least one terminal device in an active state, send the second target characters and a calling request for calling the second target model on a terminal device to the at least one terminal device through the communication channel between the at least one terminal device and the electronic device, so that each of the at least one terminal device may process the second target characters based on the second target model.

Furthermore, the information search device further includes an object acquisition module 507 configured to obtain index objects through a communication channel between at least one terminal device in an active state and the electronic device, where the index objects are used to obtain third target objects, and the third target objects are target objects that are determined based on a second target model on a terminal device and match the second target characters.

In one embodiment, the first target model includes a first generative model, and the second target model includes a second generative model.

A third target object corresponding to the index object returned by the object acquisition module may be an object generated by the terminal device based on the second generative model.

In one embodiment, the information search device further includes an object generation module, configured to generate a second target object matching the second target characters by using the first generative model if the second search engine fails to find a second target object matching the second target characters in the search box.

Correspondingly, a third target object is an object generated based on the second generative model after the terminal device fails to search for an object matching the second target characters.

In one embodiment, the call transmission module is specifically configured to send the second target characters and the calling request for calling the second target model on the terminal device to the at least one terminal device based on the intelligent model capability of the at least one terminal device.

As disclosed herein, all modules included in the electronic device may be running on one or more processors of the electronic device. Each module may be executed by corresponding processor(s) capable of performing the module's function. One or more modules may be executed by same processor(s) or different processor(s), of the electronic device.

An electronic device is further provided according to an embodiment of the present disclosure. As shown in FIG. 7, a schematic structural diagram of the electronic device is shown, and the electronic device includes at least a processor 701, an input device 702, and a display screen 703.

The processor 701 is configured to obtain a first operation through the input device; in response to the first operation, display a search box through the display screen and control the input cursor to be located in the search box; in response to the first operation, respond to each input character in the search box in real time with a first search engine, and search for first target objects that match the first target characters in the search box, and the first target characters are all the characters in the search box when responding to the input character; update the displayed first target objects in real time through the display screen; in response to a second operation obtained through the device, search for second target objects that match the second target characters in the search box with a second search engine, and the second target characters are all the characters in the search box; display the second target objects through the display screen, where the second search engine includes a first target model, and the first target model is at least configured to understand the semantics of the second target characters, and a second target object is not a character-type object.

The electronic device may further include a memory 704 for storing programs required for the processor to perform operations

Apparently, the electronic device may also have more or fewer components than those shown in FIG. 7, which is not limited in the present disclosure.

In some embodiments of the present disclosure, the first search engine is a local search engine of the electronic device, the second search engine is also a local search engine of the electronic device, and the second search engine includes a first target model, which is a large language model and may understand the semantics of the second target characters and may convert the semantics into target vector features. The target vector features are compared with a vector feature library to determine second target objects that match the second target characters.

In some embodiments, the first search engine is a local search engine of the electronic device, and the second search engine is a search engine capability provided by at least one terminal device connected to the electronic device. The electronic device may call the search engine capability provided by at least one terminal device and provide second target characters through the second search engine and the connection channel between the at least one terminal device and the electronic device, so that the second search engine provided by the at least one terminal device processes the second target characters based on each of the first target models and feeds back the second target objects to the electronic device. The target model is a large language model that may understand the semantics of the second target characters and may convert them into target vector features based on the semantics. The second target objects that match the second target characters are determined by comparing the target vector features with the vector feature library.

A computer program product is also provided in an embodiment of the present disclosure, including computer-readable instructions. When the computer-readable instructions are executed on an electronic device, the electronic device implements any one of the information search methods provided in the embodiments of the present disclosure.

A computer-readable storage medium is also provided in an embodiment of the present disclosure. The storage medium carries one or more computer programs. When the one or more computer programs are executed by an electronic device, the electronic device may implement any information search method provided in the embodiments of the present disclosure.

It should also be noted that the device embodiments described above are merely illustrative, where the modules described as separate components may or may not be physically separate, and the components displayed as modules may or may not be physical modules, that is, they may be located in one place, or they may be distributed across multiple network modules. Some or all of the modules may be selected according to actual needs to achieve the purpose of the present disclosure. In addition, in the drawings of the device embodiments provided in the disclosure, the connection relationship between the modules indicates that there is a communication connection between them, which may be specifically implemented as one or more communication buses or signal lines.

Through the descriptions of the above embodiments, those skilled in the art may clearly understand that the present disclosure may be implemented by means of software plus necessary general-purpose hardware, and apparently may also be implemented by dedicated hardware including application-specific integrated circuits, dedicated CPUs, dedicated memories, dedicated components, etc. In general, all functions performed by computer programs may be easily implemented with corresponding hardware, and the specific hardware structures used to implement the same functions may also be diverse, such as analog circuits, digital circuits, or dedicated circuits. However, for the present disclosure, software program implementation is a better implementation method in most cases. Based on this understanding, the technical solutions of the present disclosure, or the part that contributes to the existing technologies, may be embodied in the form of a software product, which is stored in a readable storage medium, such as a computer floppy disk, USB flash drive, mobile hard disk, ROM, RAM, magnetic disk or optical disk, etc., and includes a number of instructions for causing a computer device (which may be a personal computer, training equipment, or network equipment, etc.) to execute the methods described in each embodiment of the present disclosure.

In the above embodiments, all or part of the embodiments may be implemented by software, hardware, firmware, or any combination thereof. When implemented by software, all or part of the embodiments may be implemented in the form of a computer program product.

The computer program product includes one or more computer instructions. When the computer program instructions are loaded and executed on a computer, the process or function described in the embodiments of the present disclosure is generated in whole or in part. The computer may be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from a website, a computer, a training device or a data center by wired (e.g., coaxial cable, optical fiber, digital subscriber line (DSL), etc.) or wireless (e.g., infrared, wireless, microwave, etc.) mode to another website, a computer, a training device or a data center. The computer-readable storage medium may be any available medium that a computer may store or a data storage device such as a training device, a data center, etc., that includes one or more available media integrations. The available medium may be a magnetic medium, (e.g., a floppy disk, a hard disk, a magnetic tape), an optical medium (e.g., a DVD), or a semiconductor medium (e.g., a solid-state drive (SSD)).

T is claimed is:

1. An information search method, comprising:
in response to a first operation, displaying a search box and controlling an input cursor to be located within the search box;
in response to the first operation, responding in real time to each input character in the search box with a first search engine, searching for first target objects that match first target characters in the search box, wherein the first target characters are all characters in the search box when responding to the input character;
updating the first target objects displayed in real time;
in response to a second operation, searching with a second search engine for second target objects that match second target characters in the search box, wherein the second target characters are all characters in the search box; and
displaying the second target objects, wherein the second search engine includes a first target model, the first target model is configured to at least understand semantics of the second target characters, and a second target object is not a character-type object.

2. The information search method according to claim 1, further comprising:
in response to the second operation, when there is at least one terminal device in an active state, sending the second target characters and a calling request for calling a second target model on a terminal device to the at least one terminal device through a communication channel between the at least one terminal device and an electronic device, so that each of the at least one terminal device is able to process the second target characters based on the second target model.

3. The information search method according to claim 2, further comprising:
index objects obtained through the communication channel with the at least one terminal device in the active state, wherein an index object is used to obtain a third target object, which is a target object that is determined by the second target model on the at least one terminal device and matches the second target characters.

4. The information search method according to claim 1, wherein in response to the second operation, searching for the second target objects matching the second target characters in the search box using the second search engine comprises:
processing the second target characters and the first target objects based on the first target model, and determining, from the first target objects, a first target object that meets the semantics of the second target characters as a second target object.

5. The information search method according to claim 1, wherein:
searching for the first target objects that match the first target characters in the search box includes searching for a first target object whose corresponding characters match the first target characters; and
searching for the second target objects that match the second target characters in the search box using the second search engine includes using the second search engine to search for a second target object whose corresponding vector features match vector features corresponding to the second target characters in the search box.

6. The information search method according to claim 3, wherein:
the first target model includes a first generative model, and the second target model includes a second generative model; and
the third target object is an object generated by the at least one terminal device based on the second generative model.

7. The information search method according to claim 6, further comprising:
when the second search engine does not find a second target object that matches the second target characters in the search box, generating a second target object that matches the second target characters by using the first generative model,
wherein the third target object is an object generated based on the second generative model after the at least one terminal device fails to search for an object matching the second target characters.

8. The information search method according to claim 2, wherein sending the second target characters and the calling request for calling the second target model on the terminal device to the at least one terminal device through the communication channel with the at least one terminal device comprises:
sending the second target characters and the calling request for calling the second target model on the terminal device to the at least one terminal device based on an intelligent model capability of the at least one terminal device.

9. An electronic device, comprising one or more processors and a memory containing a computer program that, when being executable, causes the one or more processors to perform:
in response to a first operation, displaying a search box and controlling an input cursor to be located within the search box;
in response to the first operation, responding in real time to each input character in the search box with a first search engine, searching for first target objects that match first target characters in the search box, wherein the first target characters are all characters in the search box when responding to the input character;
updating the first target objects displayed in real time;
in response to a second operation, searching with a second search engine for second target objects that match second target characters in the search box, wherein the second target characters are all characters in the search box; and
displaying the second target objects, wherein the second search engine includes a first target model, the first target model is configured to at least understand semantics of the second target characters, and a second target object is not a character-type object.

10. The electronic device according to claim 9, wherein the one or more processors are further configured to perform:
in response to the second operation, when there is at least one terminal device in an active state, sending the second target characters and a calling request for calling a second target model on a terminal device to the at least one terminal device through a communication channel between the at least one terminal device and an electronic device, so that each of the at least one terminal device is able to process the second target characters based on the second target model.

11. The electronic device according to claim 10, wherein the one or more processors are further configured to perform:
index objects obtained through the communication channel with the at least one terminal device in the active state, wherein an index object is used to obtain a third target object, which is a target object that is determined by the second target model on the at least one terminal device and matches the second target characters.

12. The electronic device according to claim 9, wherein the one or more processors are further configured to perform:
processing the second target characters and the first target objects based on the first target model, and determining, from the first target objects, a first target object that meets the semantics of the second target characters as a second target object.

13. An electronic device, comprising:
an input device, one or more processors and a display screen, wherein the electronic device further comprises:
a search box display module running on a corresponding processor of the one or more processors and configured to, in response to a first operation received via an input device, cause the corresponding processor to present a search box in the display screen and cause the corresponding processor to control an input cursor to be located within the search box;
a first search module running on a corresponding processor of the one or more processors and configured to, in response to the first operation, cause on the a corresponding processor o respond in real time to each input character entered through the input device into the search box by implementing a first search engine to search for first target objects matching first target characters located in the search box, the first target characters being all characters within the search box when the corresponding processor responds to the input character;
a first display module running on a corresponding processor of the one or more processors and configured to cause the corresponding processor to update in real time the first target objects displayed on the display screen;
a second search module running on a corresponding processor of the one or more processors and configured to, in response to a second operation received via the input device, cause the corresponding processor to implement a second search engine to search for second target objects matching second target characters located in the search box, the second target characters being all characters within the search box; and
a second display module running on a corresponding processor of the one or more processors and configured to cause the corresponding processor to present the second target objects on the display screen,
wherein the second search engine includes a first target model configured to at least understand a semantics of the second target characters, and a second target object is not a character-type object.

14. The electronic device according to claim 13, wherein the second search module is further configured to cause the corresponding processor to process the second target characters and the first target objects based on the first target model, and determine, from the first target objects, a first target object that meets the semantics of the second target characters as a second target object.

15. The electronic device according to claim 13, wherein:
the first search module is further configured to, when searching for the first target objects matching the first target characters located in the search box, cause the corresponding processor to search for first target objects whose corresponding characters match the first target characters; and
the second search module is further configured to, when implementing the second search engine to search for the second target objects matching the second target characters located in the search box, cause the corresponding processor to implement the second search engine to search for second target objects whose corresponding vector features match vector features corresponding to the second target characters located in the search box.

16. The electronic device according to claim 13, further comprising:
a call transmission module running on a corresponding processor of the one or more processors and configured to cause a corresponding processor to respond to the second operation received via the input device and, when there is at least one terminal device in an active state, send the second target characters and a calling request, for calling a second target model on a terminal device, to the at least one terminal device through a communication channel between the at least one terminal device and the electronic device, so that each of the at least one terminal device is able to process the second target characters based on the second target model.

17. The electronic device according to claim 13, further comprising:
an object acquisition module running on a corresponding processor of the one or more processors and configured to cause the corresponding processor to obtain index objects through a communication channel between at least one terminal device in an active state and the electronic device, wherein the index objects are used to obtain third target objects, and the third target objects are target objects that are determined based on a second target model on a terminal device and match the second target characters.

18. The electronic device according to claim 17, wherein:
the first target model includes a first generative model, and the second target model includes a second generative model; and
a third target object corresponding to an index object returned by the object acquisition module is an object generated by the terminal device based on the second generative model.

19. The electronic device according to claim 18, further comprising:
an object generation module running on a corresponding processor of the one or more processors and configured to cause the corresponding processor to generate a second target object matching the second target characters by using the first generative model when the second search engine fails to find a second target object matching the second target characters in the search box,
wherein the third target object is the object generated based on the second generative model after the terminal device fails to search for an object matching the second target characters.

20. The electronic device according to claim 16, wherein the call transmission module is further configured to cause the corresponding processor to send the second target characters and the calling request for calling the second target model on the terminal device to the at least one terminal device based on an intelligent model capability of the at least one terminal device.
